(19) United States
(12) Patent Application Publication
(10) Pub. No.: US 2017/0293531 A1
(43) Pub. Date: Oct. 12, 2017

(54) SNAPSHOT BACKUP

(71) Applicant: HEWLETT PACKARD ENTERPRISE DEVELOPMENT LP, Houston, TX (US)

(72) Inventors: Mark Robert Watkins, Bristol (GB); Alastair Slater, Bristol (GB)

(21) Appl. No.: 15/507,672

(22) PCT Filed: Nov. 17, 2014
(86) PCT No.: PCT/US14/65948

§ 371 Date: Feb. 28, 2017

(51) Int. Cl. G06F 11/14

(52) U.S. Cl. CPC G06F 11/1451; G06F 11/1448; G06F 11/1453; G06F 2201/815; G06F 2201/84

(57) ABSTRACT

In one example, backing up disk array volumes creates a snapshot of a volume of a disk array. Unshared blocks between a previous snapshot and the snapshot are identified to generate an allocation map. Source-side de-duplication is performed for a stream comprising the snapshot. The unshared blocks are folded into an endpoint store that includes a full backup of the volume, to generate a synthetic full of the volume.

### BACKGROUND

To generate a consistent backup of a customer's data at a specific point in time, current solutions involve using a disk agent. The disk agent typically reads data sources, or performs image backups. Additionally, one or more streams of data may be aggregated from the source to generate a consistent backup image. The disk agent may perform incremental backups, or a full backup. In the case of incremental backups, reading through the data source may entail an extensive traversal of the data sources to identify data for backing up. For full back ups, the disk agent may perform an entire traversal of the data sources. These traversals are typically of lengthy duration, causing a delay before backup data is moved, and using up valuable resources in terms of time, and in terms of the availability of the data sources being backed up.

### BRIEF DESCRIPTION OF THE DRAWINGS

Certain exemplary embodiments are described in the following detailed description and in reference to the drawings, in which:

FIG. 1 is a block diagram of an example system for snapshot based backups and restores;

FIG. 2 is a process flow chart of a method for snapshot based backups;

FIG. 3 is a block diagram of an example synthetic full using snapshot based backups;

FIG. 4 is a block diagram of an example synthetic full using snapshot based backups and allocation maps; and

FIG. 5 is a block diagram of an example of a tangible, non-transitory, computer-readable medium that stores code configured to operate an active archiving system.

### DETAILED DESCRIPTION

One challenge in performing backups is trying to avoid backing up the same data repeatedly. For example, when performing repeated backups of a laptop, there is a likelihood of repeatedly backing up the same information. This is because some files do not change frequently, such as operating system files. Repeatedly backing up the same information is a waste of resources. It is thus useful to perform incremental backups with de-duplication.

De-duplication removes repeated data from the data being backed up. Typically, backup data is streamed. In de-duplication, this stream is chunked using a hash technique. By hashing over the chunks, the hashes can be matched against what is already backed up. Accordingly, pointers to existing hashes may be used to identify where in the data stream the duplicate data ends. In this way, the duplicate data may be removed from the stream, or ignored. For example, a backup process may send four concatenated files (A file, B file, C file, and D file) in a byte stream. During the next backup, the byte stream might include four files again, but this time, the files are A, B, D, and E. Assuming files A, B, and D are unchanged, de-duplication analyzes the byte stream and determines that files A, B, and D, are to be de-duplicated. Thus, only the E file is new, and backed up accordingly. In this way, de-duplication avoids duplicating a backup for certain parts of the stream.

More specifically, an input data stream being backed up is divided into 7 KB chunks, for example, and a hash of each subject-data chunk is dynamically generated. Each hash forms, with very high probability, a unique identifier of the data making up the chunk, such that chunks giving rise to the same hash value can be reliably considered to include the same data. In general terms, the chunk subject-data hashes are used to detect duplicate chunks of subject data and each such duplicate chunk is then replaced by its hash. As used herein, reference to a chunk of subject data is to be understood as a reference to the subject data making up a chunk rather than to the specific chunk concerned. The data output to a backup store thus includes a succession of data items, each data item being either a chunk of subject data, where this is the first occurrence in the input subject-data stream, or the hash of a chunk where the subject data of the chunk is a duplicate of that of a previously occurring chunk. Each data item (or just selected data items, such as those including subject data) may also include metadata about the corresponding chunk, this metadata being placed, for example, at the start of the data item.

Incremental backups are used in combination with synthetic fulls to generate a consistent recovery point that a customer can use. The incremental backup includes what has changed since the full backup was performed. In order to restore from the incremental backup, the full backup is used in combination with successive incremental backups to create a synthetic full. However, traversing the data stores to create backups and restores incurs costs for processing and media traversal.

Examples of the claimed subject matter perform incremental backups and restores based on snapshots of the backed up data. In such examples, the differences between successive snapshots are used to identify the incremental changes in a backed-up volume.

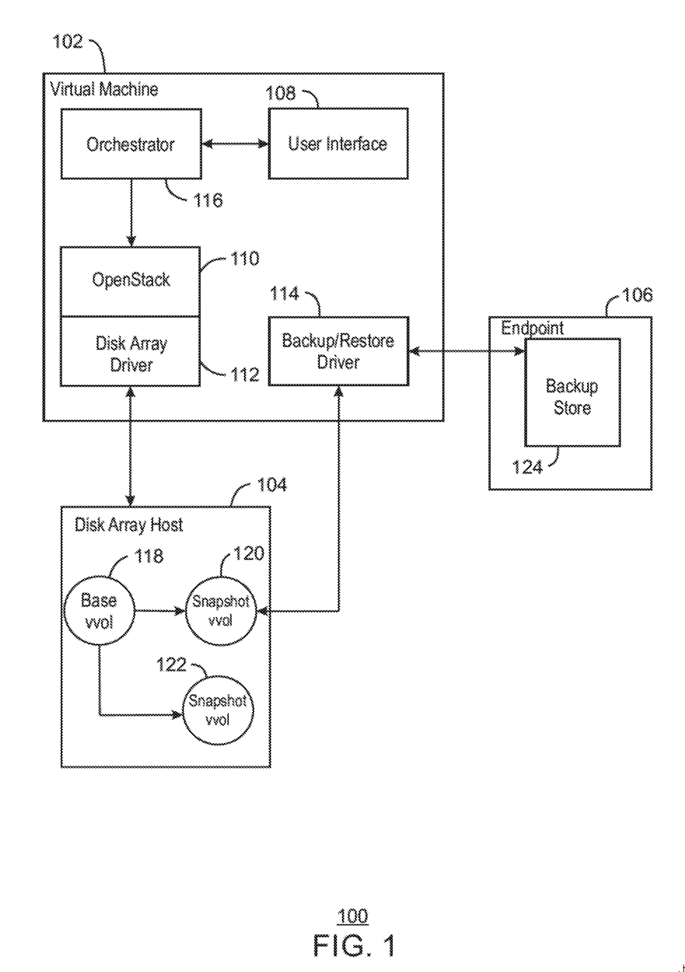

FIG. 1 is a block diagram of an example system 100 for snapshot based backups and restores. The functional blocks and devices shown in FIG. 1 may include hardware elements including circuitry, software elements including computer code stored on a tangible, non-transitory, machine-readable medium, or a combination of both hardware and software elements. Additionally, the functional blocks and devices of the system 100 are but one example of functional blocks and devices that may be implemented in examples. The system 100 includes a virtual machine 102, a disk array host 104, and an endpoint 106. The virtual machine 102 is a virtual machine image for use with a disk array. The virtual machine 102 includes a number of underlying disk volumes (not shown) which are hosted upon the disk array host 104. The disk array host 104 provides one or more disk volumes for client customers. The endpoint 106 is a repository for backups that performs de-duplication. Accordingly, the endpoint 106 is also used as the source for restores of backed up volumes.

The virtual machine 102 includes a user interface 108, OpenStack components 110, disk array driver 112, backup and restore driver 114, and an orchestrator 116. The user interface 108 is used for requesting, or scheduling, backups and restores. The OpenStack components 110, and the disk array driver 112 provide disk array agnostic support for snapshots. The catalogue keeps track of what data is backed up and when. The OpenStack components 110 in combination with the backup and restore driver manage the physical disk array and the production of snapshots. The backup and restore driver 114 moves the data from the disk array to the endpoint 106. The virtual machine 102 includes an orchestrator 116 for scheduling backups, and a user interface 108 for interaction with the customers. The orchestrator 116 orchestrates the activities of the user interface 108. the open stack 110, the disk array driver 112, and the backup and restore driver 114.

The disk array host 104 is a physical disk array platform for disk arrays with snapshot functionality. For all backed up volumes, the disk array host 104 includes a base virtual volume (vvol) 118 and snapshot vvols 120. The first backup performed for each volume is a full backup, stored in, the base vvol 118 and possibly backed up to some arbitrary endpoint e.g., a StoreOnce data protection device that de-duplicates data. When performing subsequent backups, the backup and restore driver 114 determines what data has changed since the most recent backup. Typically, making this determination is performed via an application programming interface (API) call to the endpoint 106, or through a namespace traversal over file directories, or database tables, for example. In examples of the claimed subject matter, the backup and restore driver 114 makes this determination using the snapshot vvols 120. Advantageously, a snapshot of a disk volume can be taken at a nearly instantaneous point in time.

The endpoint 106 is able to fold in specific changes at fixed block byte extent ranges as updates from a given ancestor base vvol 118 or snapshot vvol 120. For example, the updates may include a list of changed blocks at specific offsets, plus a number of changed bytes at those offsets.

In one example, the disk array volumes are thinly provisioned. In other words, the disk array volumes advertise a capacity range that may be far in excess of the realizable capacity on the underlying physical hardware. Thinly provisioned volumes may be used in scenarios where the underlying use of physical storage is provided on demand. Thus, the full amount of a volume's storage is not fully allocated up front. As such, a virtual volume may have, for example, 1 GB of actual storage, and 100 GB of unprovisioned storage. Thus, an allocation map is used which specifies which sectors of the volume are populated and which are not. The disk array driver 112 can detect whether or not a sector has been written, so space is not consumed for sectors that are either unwritten or full of zeroes.

The disk array driver 112 has a programmable interface to create a snapshot of a specific virtual volume. The snapshot may be crash consistent or application consistent. Crash consistent means the snapshot is of the given disk volume at a specific the point in time. It is not possible to know what an application using that volume may be doing at that point in time, but the likelihood is that the virtual volume is recoverable for applications that have crashed. Application consistent means there is an application running when the snapshot is taken. In such a scenario, the disk array driver 112 can determine what the application is doing to the underlying disk volume, and the application can ensure that any pending IOs are not left in flight. In this way, the snapshot provides an application consistent recovery point because any pending IOs, for example, are flushed from client buffer memory, or other page cache, before the snapshot is taken.

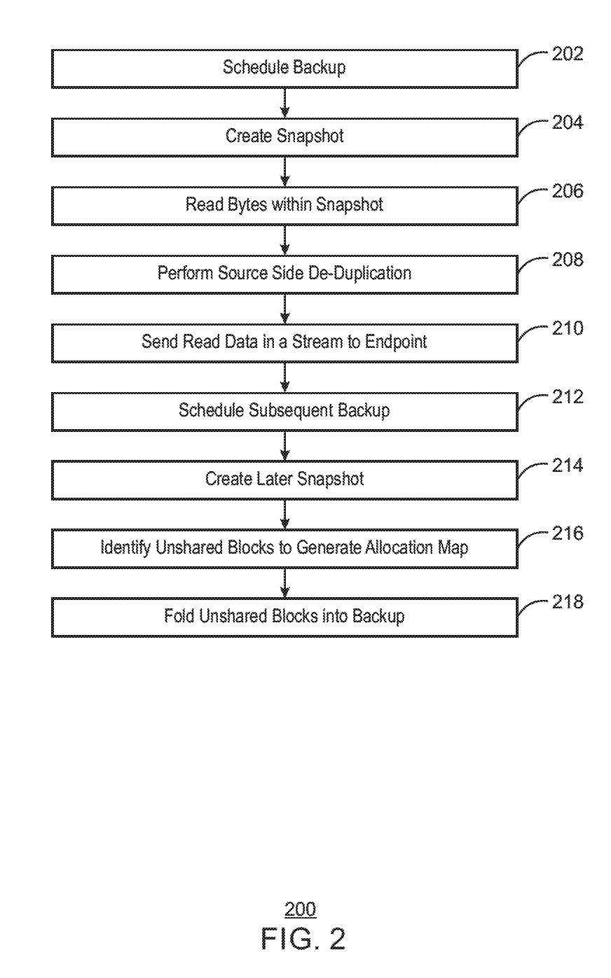

FIG. 2 is a process flow chart of an example method 200 for snapshot based backups. The method begins at block 202, where the orchestrator 108 schedules a backup. The backup may be requested by a customer, or scheduled according to policies for the customer, or the data center.

At block 204, the OpenStack components 110, in concert with the disk array driver 112, cause the disk array host 104 to create a read-only snapshot virtual volume (vvol) 120 from an underlying base vvol 118. At block 206, the backup and restore driver 114 reads the data bytes within snapshot vvol 120. At block 208, the backup and restore driver 114. At block 208, the backup and restore driver 114 uses an application programming interface (API) provided by the endpoint 106 to perform source side de-duplication.

At block 210, the data read is sent in a data stream as a backup image to the end-point backup store 124. The first time that the base vvol 118 is backed up, a full backup is performed. However, reading all the data bytes within the vvol 120 is a potentially slow process. Thus, in examples, synthetic full technology is used to reduce the amount of reading performed in subsequent backups. A synthetic full is a full image that is created by a derivation of a later image against some common ancestor image.

At block 212, the orchestrator schedules a subsequent backup. At block 214, the base vvol 118 is snapshotted to generate a dater snapshot vvol 122. At block 216, the disk array host identifies the unshared blocks between the later snapshot vvol 122 and the earlier snapshot vvol 120 by generating an allocation map. Due to the array snapshot functionality being ‘copy on write’, any shared blocks contain the same data. In contrast, blocks that are written, or re-written, after creating the later snapshot vvol 122 are unshared blocks. The disk array host 104 may allow the detection of the unshared blocks via the use of a ‘show allocation map’ command. This command may be available via a command line interface (CLI), or any other transport, such as REST (Representational state transfer).

Allocation maps may be character-based and provide four bits per character. As such, the maximal value for a single character is ‘f’ in hexadecimal, which accounts for all four bits set. The allocation map can be queried for a specific blocksize, with four bits allowing for four blocks worth of difference that can be detected per character. An allocation map of unshared blocks between snapshot vvol 120 and later snapshot vvol 122 contain a ‘0’ for each shared character, i.e., common data in both snapshots. Where the allocation map contains nonzero are unshared blocks, and hence changes present in later snapshot vvol 122 that were not in snapshot vvol 120. In this way, the allocation map identifies a fixed block offset, plus a number of changed blocks by the character position and value in the allocation map.

At block 218, the endpoint 106 folds the unshared blocks into the backup 124. Due to disk arrays being fixed block based devices, this matches up well Thus given a disk snapshot, a difference of the older snapshot to the newer can be generated quickly, assuming there is a common ancestor, and the unshared blocks can be used to read only those blocks that are different to generate a synthetic full. Synthetic fulls are called synthetic because they are effectively the same as a full backup of an underlying snapshot. However, the synthetic full is derived from an original full plus the changed blocks, i.e., deltas.

In the case of restores, data flows in the opposite direction, from the backup 124 in the deduplicating endpoint 106 to a writable snapshot, for example, later snapshot vvol 124. It should be noted that as long as there is some ancestor, then the appropriate difference can be generated, and this may include the identification of any coincident source deduplicating object to merge the changes into.

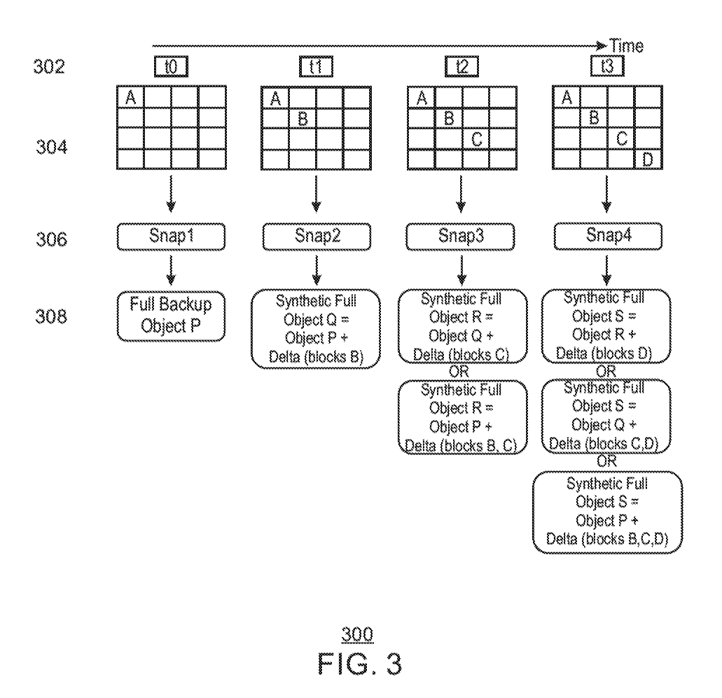

FIG. 3 is a block diagram 300 of example synthetic fulls generated using snapshot based backups. The block diagram 300 shows times 302, disk volume matrices 304, snapshots 306, and combinations 308 for generating synthetic fulls. The times 302 represent times at which backups are performed, and include times t0, t1, t2, and t3. The volume matrices 304 are representations of the changes between backups, i.e., the deltas between the previous backup at time, tₙ₋₁ and tₙ. The snapshots 306 represent the full volume images, snapₙ₊₁, taken at time, tₙ.

The combinations 308 define object combinations for creating a synthetic full. As stated previously, incremental backups may be stored as data objects. Thus, each combination 308 at time, tₙ, defines the objects used to create the synthetic full representing the backed up disk volume at time, tₙ. Each combination 308 includes two object types, ancestor and delta. The ancestor represents a complete disk image at time tₙ₋ₓ, and the deltas at time, tₙ₋ₓ₊₁, tₙ₋ₓ₊₂, . . . and tₙ.

At time, t₀, there is no ancestor. Hence, snap1 is used to create a full backup. The combination 308 at t₀ is simply the full backup, referenced here as object P. At t₁, the matrix 304 includes deltas A and B, where delta B represents the changes to the disk volume between times t₀ and t₁. Snap2 is used to create the backup at time t₁. A synthetic full for t₁ is referenced here as object Q. The combination 308 used to create Q includes object P and delta B.

At time t₂, the matrix 304 includes deltas A, B, and C, where delta. C represents the changes to the disk volume between times t₁ and t₂. Snap3 is used to create the backup at time t₂. A synthetic full for t₂ is referenced here as object R. Two combination 308 are possible for creating. R: object Q and delta C, or object P and deltas B and C. At time, t₃ the matrix 304 includes deltas A, B, C, and D, where delta D represents the changes to the disk volume between times t₂ and t₃. Snap4 is used to create the backup at time t₃. A synthetic full for t₃ is referenced here as object S. Three combination 308 are possible for creating S: object R and delta D, object Q and deltas C and D, or object P and deltas B, C and D.

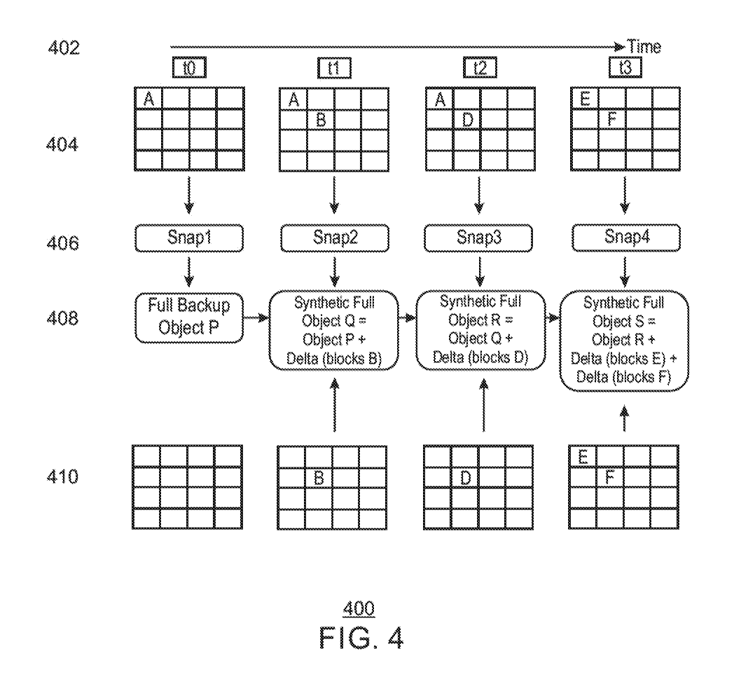

FIG. 4 is a block diagram 400 of example synthetic fulls using snapshot based backups and allocation maps. The block diagram 400 shows times 402, disk volume matrices 404, snapshots 406, combination 408, and allocation maps 410. The times 402 represent times at which backups are performed, and include times t0, t1, t2, and t3. The volume matrices 404 are representations of the changes between backups, i.e., the deltas between the previous backup at time, tₙ₋₁ and tₙ. The snapshots 406 represent the full volume images, snapₙ₊₁, taken at time, tₙ.

The combination 408 defines the object combinations for creating a synthetic full. Thus, each combination 408 at time, tₙ, defines two objects, an ancestor and a delta, used to create the synthetic full representing the backed up disk volume at time, tₙ.

At time, t₀, there is no ancestor. Hence, snap1 is used to create a full backup. The combination 408 at t₀ is simply the full backup, referenced here as object P. At time t₁, the matrix 404 includes deltas A and B, where delta B represents the changes to the disk volume between times t₀ and t₁.

For time t1, difference is blocks B applied over and above Snap1, which are new. Snap2 is used to create the backup at time t₁. A synthetic full for t₁ is referenced here as object Q. The combination 408 used to create Q includes object P and delta B. Delta B is represented in the allocation map 310.

For time t2, blocks at D have changed and hence are unshared, i.e., different from those present at the same offset in Snap2. Hence, the unshared blocks between Snap3 and Snap2 show D as its delta. For time t3, the allocation map shows the same blocks in use as at Snap3, but with new unshared blocks, E and F. E and F represent changes to the blocks A and D from time t2. The combination 408 at time t3 indicates an object S is created using object R and deltas for the blocks at E and F.

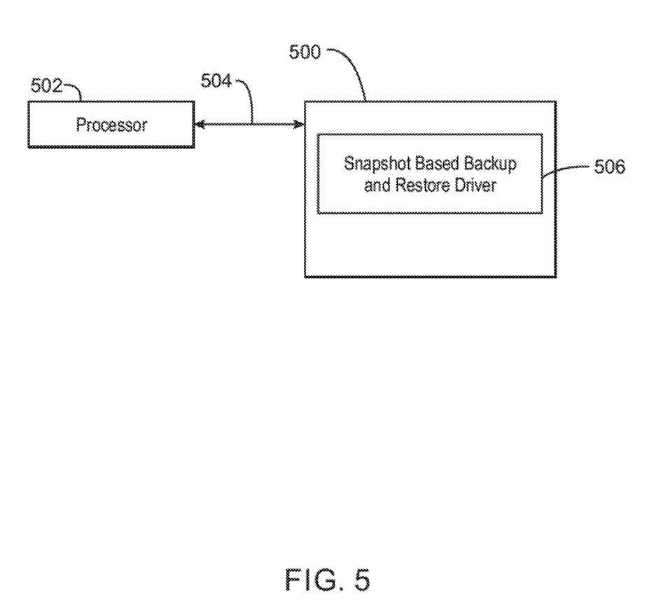

FIG. 5 is a block diagram of an example of a tangible, non-transitory, computer-readable medium that stores code for snapshot based backups and restores. The computer-readable medium is referred to by the reference number 500. The computer-readable medium 500 can include RAM, a hard disk drive, an array of hard disk drives, an optical drive, an array of optical drives, a non-volatile memory, a flash drive, a digital versatile disk (DVD), or a compact disk (CD), among others. The computer-readable medium 500 can be accessed by a controller 502 over a computer bus 504. Further, the computer-readable medium 500 may include a snapshot based backup and restore driver 506 to perform the methods and provide the systems described herein. The various software components discussed herein may be stored on the computer-readable medium 500.

Advantageously, examples of the present techniques provide backups and restores based on snapshots generated of a full volume image. Performing backups and restores in this manner reduces the amount of time used in current techniques.

While the present techniques may be susceptible to various modifications and alternative forms, the exemplary examples discussed above have been shown only by way of example. It is to be understood that the technique is not intended to be limited to the particular examples disclosed herein.

What is claimed is:

1. A method for backing up disk array volumes, comprising:
creating a snapshot of a volume of a disk array;
identifying unshared blocks between a previous snapshot and the snapshot to generate an allocation map;
performing source-side de-duplication for a stream comprising the snapshot; and
folding the unshared blocks into an endpoint store comprising a full backup of the volume to generate a synthetic full of the volume.

2. The method of claim 1, comprising:
creating the previous snapshot for the volume;
reading all data bytes of the previous snapshot to generate a full backup; and
sending the de-duplicated stream to an endpoint store to generate the full backup.

3. The method of claim 1, wherein the allocation map comprises zeroes for all shared blocks between the snapshot and the previous snapshot.

4. The method of claim 1, wherein the allocation map comprises non-zeroes for the unshared blocks.

5. The method of claim 1, wherein the endpoint store comprises an object associated with the synthetic full.

6. The method of claim 5, comprising restoring the volume from the synthetic full.

7. A computing system, comprising:
a processor; and
a memory comprising code executed to cause the processor to:
create a snapshot of a volume of a disk array;
identify unshared blocks between a previous snapshot and the snapshot to generate an allocation map; and
perform source-side de-duplication for a stream comprising the snapshot; and
fold the unshared blocks into an endpoint store comprising a full backup of the volume to generate a synthetic full of the volume.

8. The computing system of claim 7, the code executed to cause the processor to:
create the previous snapshot for the volume;
read all data bytes of the previous snapshot to generate a full backup; and
send the de-duplicated stream to an endpoint store to generate the full backup.

9. The computing system of claim 7, wherein the allocation map comprises zeroes for all shared blocks between the snapshot and the previous snapshot.

10. The computing system of claim 7, wherein the allocation map comprises non-zeroes for the unshared blocks.

11. The computing system of claim 7, wherein the endpoint store comprises an object associated with the synthetic full.

12. The computing system of claim 11, code executed to cause the processor to restore the volume from the synthetic full.

3. A tangible, non-transitory, computer-readable medium comprising ions that direct a processor to:
create a snapshot of a volume of a disk array;
identify unshared blocks between a previous snapshot and the snapshot to generate an allocation map; and
perform source-side de-duplication for a stream comprising the snapshot;
fold the unshared blocks into an endpoint store comprising a full backup of the volume to generate a synthetic full of the volume;
create the previous snapshot for the volume;
read all data bytes of the previous snapshot to generate a full backup;
send the de-duplicated stream to an endpoint store to generate the full backup.

14. The tangible, non-transitory, computer-readable medium of claim 13, wherein the allocation map comprises:
zeroes for all shared blocks between the snapshot and the previous snapshot; and
non-zeroes for the unshared blocks.

15. The tangible, non-transitory, computer-readable medium of claim 13, the processor directed to restore the volume from the synthetic full.
